(19) United States
(12) Patent Application Publication
(10) Pub. No.: US 2007/0159312 A1
(43) Pub. Date: Jul. 12, 2007

(54) Motor Vehicle Comprising A Sensor For Detecting An Obstacle In The Surroundings Of The Motor Vehicle

(76) Inventors: Pao Hsu Chen, Milpitas, CA (US); Daniel Rosario, Santa Cruz, CA (US); Anne Stoschek, Palo Alto, CA (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/566,314

(22) Filed: Dec. 4, 2006

Related U.S. Application Data
(60) Provisional application No. 60/741,937, filed on Dec. 2, 2005.

(51) Int. Cl. B60Q 1/00

(52) U.S. Cl. 340/435

(57) ABSTRACT

A motor vehicle has a sensor for detecting an obstacle in the surroundings of the motor vehicle and a control system for assigning the symbol for identifying the detected obstacle to the image of said surroundings of the motor vehicle, wherein the position of the symbol in relation to the image corresponds substantially to the position of the obstacle in the image, and wherein a display arrangement is provided for representing the image of said surroundings of the motor vehicle together with the symbol.

### CROSS-REFERENCE TO RELATED APPLICATIONS

This application claims the benefit of U.S. Provisional Application No. 60/741,937 filed on Dec. 2, 2005, entitled “KRAFTFAHRZEUG MIT EINEM SENSOR ZUM ERKENNEN EINES HINDERNISSES IN EINER UMGEBUNG DES KRAFTFAHRZEUGES”, which is incorporated herein in its entirety.

### TECHNICAL FIELD

The invention relates to a motor vehicle comprising a sensor for detecting an obstacle in the surroundings of the motor vehicle.

### BACKGROUND

EP 1 343 022 A1 discloses a method and a system for detecting objects in the proximity of a vehicle and/or for the preventive collision warning of a vehicle, said system comprising a camera, which is arranged on the vehicle and which detects the proximity or the surroundings of the vehicle, a light source, which transmits a beam in the region detected by the camera, wherein the transmitted beam reflected on the road surface or on the object is reflected on the receiver array of the camera and the presence of objects in the path of the transmitted beam is determined from the position of the reflected transmitted beam on the receiver array.

DE 103 55 249 A1 discloses a motor vehicle movement assisting system comprising at least one radar device for measuring a distance between the radar device and an object, a speed difference between the radar device and the object or an angle between a beam direction of the radar device and the object by emitting a transmitted signal and receiving a part of the transmitted signal, said part being reflected by the object, wherein the transmitted signal can be adjusted as a function of at least one operation value of the motor vehicle.

Devices for detecting the surroundings of a motor vehicle have been disclosed e.g., in DE 42 22 409 C2, EP 0 361 188 B1, DE 195 18 978 C2, DE 103 08 168 A1, DE 103 47 976 A1, and DE 103 57 704 A1.

The Internet site www.german-helicopter.com/Pages/content/cont discloses an obstacle-warning sensor for a helicopter. This obstacle-warning sensor is an imaging laser radar having a fiber-optic scanner architecture, using, which especially wires and wire-like objects are detected. The fiber-optic scanner is based on two rotating mirrors seated on a joint shaft. The fiber optic transforms the movement of the rotating mirrors into a linear beam deflection.

The journal Technisches Messen, 71 (2004) 3, pages 164 to 172 discloses a method for detecting the surroundings of a vehicle based on a multi-line laser scanner as a sensor.

The Fraunhofer-Institut für Physikalische Messtechnik IPM, Heidenhofstrasse 8, 79110 Freiburg, Germany offers an impulse laser radar, which is suitable for use in rapidly scanning 2D and 3D measuring systems and also for the distance and speed measurement of very rapid, explosive process sequences.

DE 42 22 642 A1 discloses a picture detecting sensor unit comprising a passive sensor, which resolves a field of view into picture elements having different brightness, and picture processing means arranged downstream of said sensor, wherein an additional active LADAR sensor is provided with a laser which emits a scanning beam, and signals indicating the distance are generated from the illumination reflected from surfaces in the field of view.

### SUMMARY

It is the object of the invention to increase the safety when operating a motor vehicle, especially when reversing. The appropriate solution should be suitable for the serial-production use in a motor vehicle.

The aforementioned object is attained by a motor vehicle, which comprises
a sensor for detecting an obstacle in the surroundings of the motor vehicle,
a control system for integrating a symbol for identifying the detected obstacle into the image of said surroundings of the motor vehicle, or for assigning the symbol for identifying the detected obstacle to the image of said surroundings of the motor vehicle, the position of the symbol in relation to the image corresponding substantially to the position of the obstacle in the image, and
a display arrangement for representing the image of said surroundings of the motor vehicle together with the symbol.

In a design form of the invention, the symbol comprises a specification related to a distance between the motor vehicle and the obstacle or is designed as a specification related to a distance between the motor vehicle and the obstacle.

In another design form of the invention, the distance between the motor vehicle and the obstacle can be determined by the control system by means of the travel time measurement, particularly by means of interferometry. In doing so, the travel time of an emitted light beam and a light beam reflected on an obstacle (whose distance from the motor vehicle is to be determined) is measured.

In another design form of the invention, the symbol comprises a warning related to the obstacle or is designed as a warning related to the obstacle.

In another design form of the invention, the symbol comprises a specification related to a distance between the motor vehicle and the obstacle and also a warning related to the obstacle.

In another design form of the invention, the sensor comprises a laser for emitting a light beam.

In another design form of the invention, the sensor comprises a camera adapted especially to a wavelength of the light beam. Such a camera is designed especially as an infrared camera (IR) or as a near-infrared camera (NIR).

In another design form of the invention, the sensor comprises a two-dimensional scanning device for moving the light beam into a first plane and also into a second plane orthogonal to the first plane, wherein the light beam is deflected in the surroundings of the motor vehicle. In one embodiment, the two-dimensional scanning device comprises an MEMS (Micro-Electro-Mechanical System) or is designed as an MEMS. The two-dimensional scanning device can also be designed as an acousto-optical crystal (AOC), galvanometer mirror, or switchable grating. The aforementioned camera serves to detect a part of the light beam, said part being reflected by said surroundings of the motor vehicle.

In another design form of the invention, the distance between the motor vehicle and the obstacle can be determined by means of the control system by measuring the thermal intensity in one wavelength of the light beam.

In another design form of the invention, the sensor comprises a mirror for reflecting the light beam in the surroundings of the motor vehicle, said mirror being connected to a first torsional element having a first torsional axis, said first torsional element being connected to a second torsional element having a second torsional axis, said first torsional axis being directed substantially orthogonal to the second torsional axis or the first torsional axis having at least one component that is orthogonal to the second torsional axis.

The aforementioned object is attained by a method for operating a motor vehicle, wherein an obstacle in the surroundings of the motor vehicle is detected, wherein an image of said surroundings of the motor vehicle is detected and wherein the image of said surroundings of the motor vehicle is represented together with a symbol for identifying a detected obstacle, said symbol lying over the image at a position, which corresponds substantially to the position of the obstacle in the image.

The aforementioned object is attained by a motor vehicle, which comprises
a laser for emitting a light beam,
a mirror for reflecting the light beam in the surroundings of the motor vehicle, wherein the mirror is connected to a first torsional element having a first torsional axis, wherein the first torsional element is connected to a second torsional element having a second torsional axis, and wherein the first torsional axis is directed substantially orthogonal to the second torsional axis or the first torsional axis has at least one component that is orthogonal to the second torsional axis, and
a camera for detecting a part of the light beam, said part being reflected by said surroundings of the motor vehicle.

In a design form of the invention, the motor vehicle comprises a control system for determining a distance between the motor vehicle and the obstacle. In another design form of the invention, the distance between the motor vehicle and the obstacle can be determined by the control system by means of a travel time measurement, especially using interferometry, and/or by measuring the thermal intensity in one wavelength of the light beam.

The aforementioned object is attained by a motor vehicle, said motor vehicle comprising
a laser for emitting a light beam,
a two-dimensional scanning device for moving the light beam in a first plane and also in a second plane orthogonal to the first plane, said light beam being deflected in the surroundings of the motor vehicle, and
a camera for detecting a part of the light beam, said part being reflected by said surroundings of the motor vehicle.

In a design form of the invention, the motor vehicle comprises a control system for determining the distance between the motor vehicle and the obstacle. In another design form of the invention, the distance between the motor vehicle and the obstacle can be determined by the control system by means of a travel time measurement, especially using interferometry, and/or by measuring the thermal intensity in a wavelength of the light beam.

An image of said surroundings of the motor vehicle can be determined e.g., by means of the camera mentioned in connection with the invention. However, an additional camera can also be provided.

The aforementioned object is attained by a motor vehicle, which comprises
a sensor arrangement for determining the distance between the motor vehicle and an obstacle in the surroundings of the motor vehicle and also for determining the contour of the obstacle,
a control system for integrating a specification related to the distance between the motor vehicle and a detected obstacle into the contour of the detected obstacle or for assigning said specification and said contour and
a display arrangement for representing said contour together with said specification, wherein the position of said specification lies in the vicinity of the position of said contour.

In a design form of the invention, the distance between the motor vehicle and the obstacle can be determined by means of a travel time measurement, especially by means of interferometry.

In another design form of the invention, the sensor arrangement comprises a laser for emitting a light beam. In another embodiment of the invention, the sensor arrangement further comprises a camera adapted to a wavelength of the light beam.

In another design form of the invention, the sensor arrangement comprises a two-dimensional scanning device for moving the light beam in a first plane and also in a second plane orthogonal to the first plane, wherein the light beam is deflected in the surroundings of the motor vehicle. In a design form, the two-dimensional scanning device comprises an MEMS (Micro-Electro-Mechanical System) or is designed as an MEMS. The two-dimensional scanning device can also be designed as an acousto-optical crystal (AOC), galvanometer mirror, or switchable grating. The aforementioned camera serves to detect a part of the light beam, said part being reflected by said surroundings of the motor vehicle.

In another design form of the invention, the sensor arrangement comprises a camera for detecting a part of the light beam, said part being reflected by said surroundings of the motor vehicle.

In another design form of the invention, the sensor arrangement comprises a laser for emitting a light beam, a two-dimensional scanning device for moving the light beam in a first plane and also in a second plane orthogonal to the first plane, wherein the light beam is deflected in the surroundings of the motor vehicle, and a camera adapted to a wavelength of the light beam for detecting a part of the light beam, said part being reflected by said surroundings of the motor vehicle.

In another design form of the invention, the distance between the motor vehicle and the obstacle can be determined by measuring the thermal intensity in a wavelength of the light beam.

In another design form of the invention, the sensor arrangement comprises a laser for emitting a light beam and a mirror for reflecting the light beam in the surroundings of the motor vehicle, wherein the mirror is connected to a first torsional element having a first torsional axis, wherein the first torsional element is connected to a second torsional element having a second torsional axis, and wherein the first torsional axis is directed substantially orthogonal to the second torsional axis or the first torsional element has at least one component that is orthogonal to the second torsional axis.

A motor vehicle within the meaning of the invention is especially a land vehicle, which can be used individually in road traffic. Motor vehicles within the meaning of the invention are especially not limited to land vehicles having an internal combustion engine.

Additional advantages and details will become apparent from the following description of example embodiments.

### BRIEF DESCRIPTION OF THE DRAWINGS

FIG. 1 illustrates an example embodiment of a motor vehicle;

FIG. 2 illustrates an example embodiment of an obstacle sensor;

FIG. 3 illustrates an example embodiment of a two-dimensional scanning device;

FIG. 4 illustrates a possible scenario, in which two children and are present behind a motor vehicle;

FIG. 5 illustrates an example embodiment of a method for operating the motor vehicle;

FIG. 6 illustrates an example embodiment of a representation by means of a display arrangement;

FIG. 7 illustrates an example embodiment of another representation by means of a display arrangement;

FIG. 8 illustrates an example embodiment of another representation by means of a display arrangement; and

FIG. 9 illustrates an example embodiment of another representation by means of a display arrangement.

### DETAILED DESCRIPTION

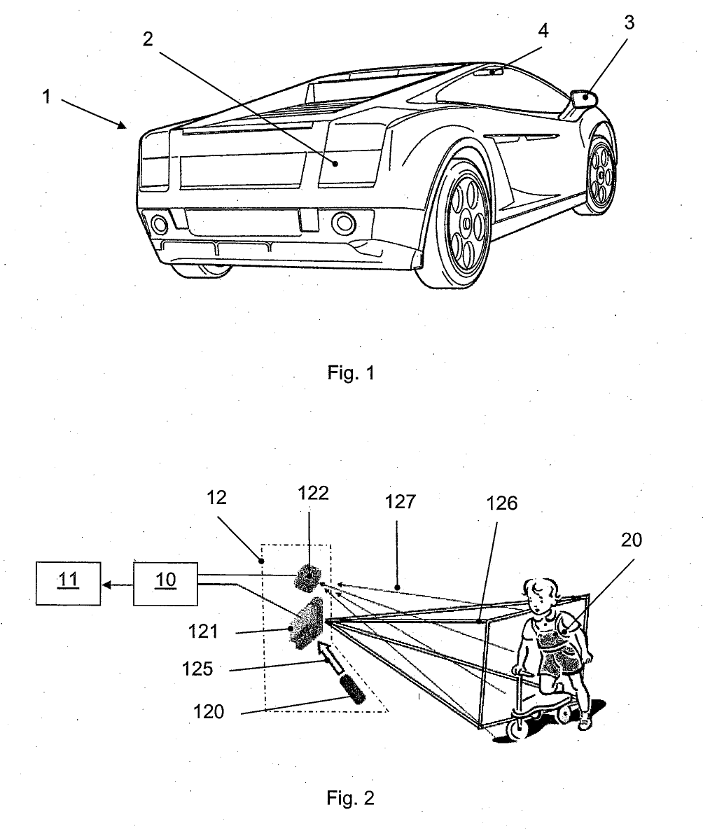

FIG. 1 illustrates an example embodiment of a motor vehicle 1. The motor vehicle 1 comprises an obstacle sensor 12, described with reference to FIG. 2, for detecting an obstacle or an object at risk, as the child in FIG. 2 indicated by reference numeral 20, in the rear surroundings of the motor vehicle 1 in particular. The obstacle sensor 12 can be integrated into e.g., the rear end and/or into a side mirror 3 of the motor vehicle 1. The obstacle sensor 12 can also be integrated into e.g., a rear light 2 of the motor vehicle 1. Alternatively, the obstacle sensor 12 can also be integrated into e.g., a bumper or a hatchback.

The obstacle sensor 12 illustrated in FIG. 2 comprises a laser 120 for emitting a light beam 125 in the infrared range or in a near-infrared range and also a two-dimensional scanning device 121 for moving the light beam 125 in a first plane and also in a second plane orthogonal to the first plane, wherein the light beam is deflected in the surroundings of the motor vehicle. In this way, a region indicated by reference numeral 126 is illuminated or scanned by means of the light beam 125. Furthermore, the obstacle sensor 12 comprises a camera 122 adapted to a wavelength of the light beam 125 for detecting a part 127 of the light beam 120, said part 127 being reflected in this region by the illuminated surroundings of the motor vehicle 1 or by an obstacle or by an object at risk, such as the child 20.

The motor vehicle I comprises a control system 10 for evaluating an output signal of the camera 122 or for determining the distance between the motor vehicle 1 and an obstacle. In a possible design form, the distance between the motor vehicle 1 and the obstacle can be determined by means of a travel time measurement, especially using interferometry. Alternatively or additionally, provision can be made for the distance between the motor vehicle 1 and the obstacle to be determinable by measuring the thermal intensity in a wavelength of the light beam 120. As described by way of example with reference to FIG. 6, the control system 10 additionally serves to integrate a symbol for identifying a detected obstacle into an image of the scanned surroundings of the motor vehicle 1 or for assigning the symbol for identifying the detected obstacle to the image of the scanned surroundings of the motor vehicle 1, wherein the position of the symbol in relation to the image corresponds substantially to the position of the obstacle in the image.

The symbol and the image can be represented by means of a display arrangement 11. The display arrangement 11 can comprise e.g., only one display. In this case, the symbol is represented by means of the display such that said symbol is integrated into the image. Provision can also be made for the display arrangement 11 to comprise two displays arranged above one another, wherein a transparently designed front display in relation to the line of view is arranged in front of the other rear display. In this case, provision can be made for the image to be represented by means of the rear display and the symbol to be represented by means of the front display. The display arrangement 11 is arranged in the passenger compartment of the motor vehicle 1. The display arrangement 11 can be integrated e.g., into the steering wheel of the motor vehicle 1 or the dashboard, optionally in the instrument cluster of the motor vehicle 1. The display arrangement 11 can also be integrated into the rearview mirror 4 of the motor vehicle 1.

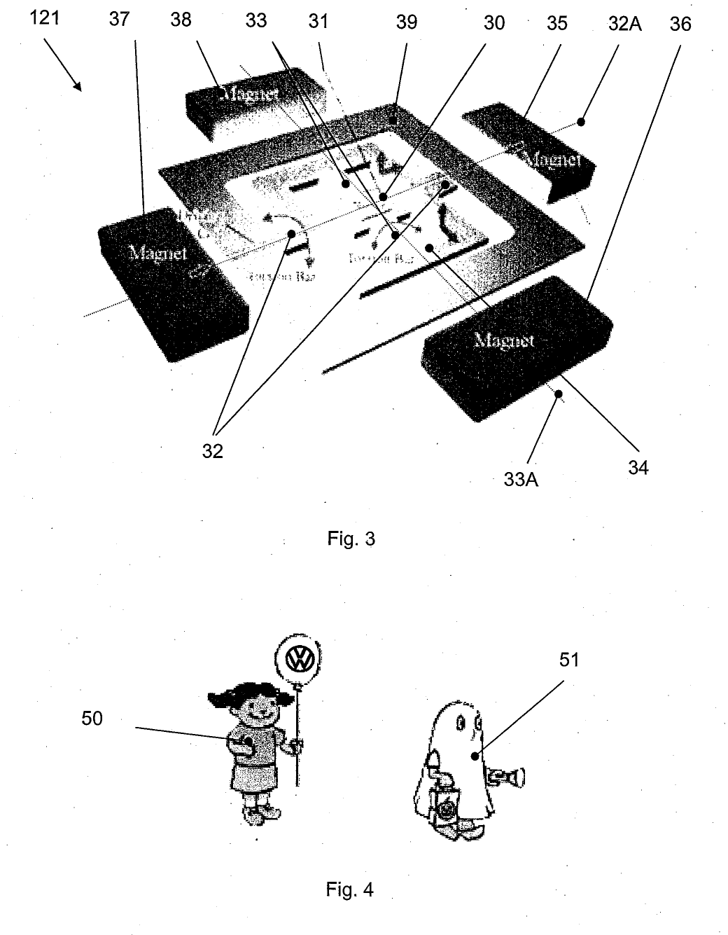

The two-dimensional scanning device 121 can be designed as an acousto-optical crystal (AOC), galvanometer mirror, or switchable grating. In the present example embodiment, the two-dimensional scanning device 121 is designed as MEMS (Micro-Electro-Mechanical System) corresponding to FIG. 3. The two-dimensional scanning device 121 comprises a mirror 30 fixed on a plate 31, said plate 31 being connected to a frame 34 using a torsional element 33. The frame 34 is in turn connected to a frame 39 using a torsional element 32. The torsional axis 32A of the torsional element 32 is directed substantially orthogonal to the torsional axis 33A of the torsional element 33. Four permanent magnets 35, 36, 37, and 38 are arranged around the frame 39. The plate 31 and the frame 34 are connected using windings. The plate 31 and the frame 34 can be moved in such a way by means of the current flowing through the windings that the light beam 120 illuminates or scans the region indicated by reference numeral 126.

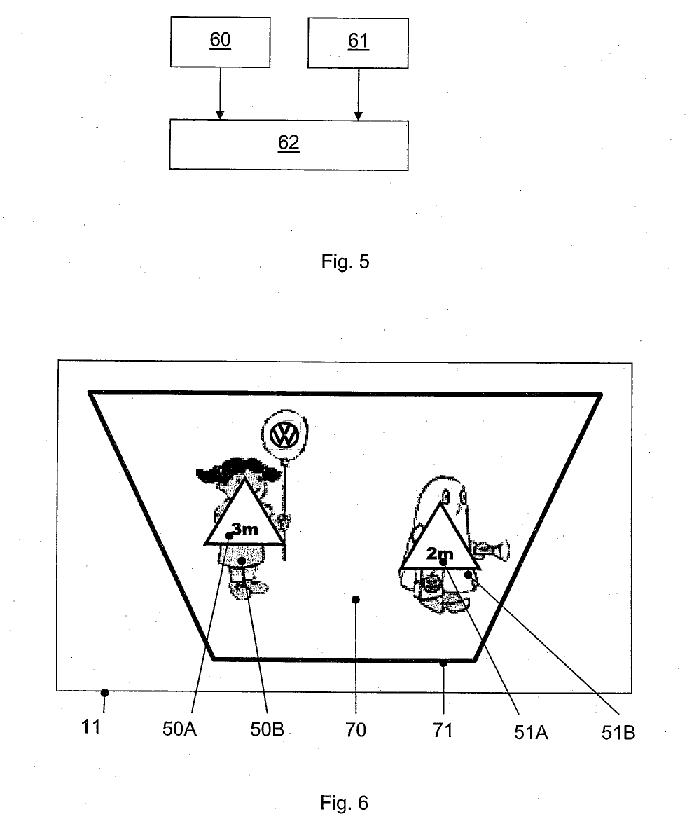

FIG. 4 illustrates a possible scenario, in which two children 50 and 51 are present behind the motor vehicle 1. FIG. 5 illustrates a method for operating the motor vehicle 1. The children 50 and 51 are detected in step 60 as obstacles or objects at risk. Furthermore, the distance between the motor vehicle 1 and the children 50 and 51 is determined. In parallel thereto, an image of the surroundings behind the motor vehicle 1 is detected in step 61. Steps 60 and 61 are followed by step 62, in which, as illustrated in FIG. 6, the imaging 70 of the surroundings behind the motor vehicle 1 together with symbols 50A and 51A for identifying the children 50 and 51 is represented by means of the display arrangement 11, the symbols 50A and 51A superimposing over the FIGS. 50B and SIB of the children 50 and 51. In addition, the light beam 125 superimposes over the boundary 71 of the scanning. In the example embodiment illustrated, the symbols 50A and 51A each comprises a red triangle and a specification related to the distance between the motor vehicle 1 and the respective child 50 and 51.

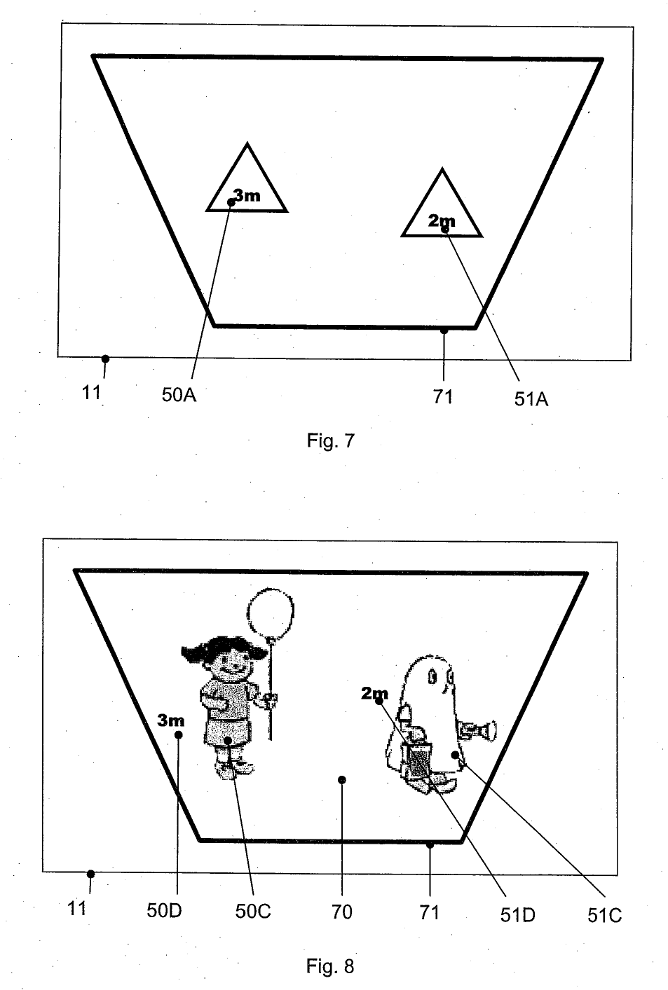

FIG. 7 illustrates an alternative example embodiment of a representation by means of the display arrangement 11, wherein the representation shown in FIG. 7 corresponds to that shown in FIG. 6, however without the imaging 70.

FIG. 8 illustrates another alternative example embodiment of a representation by means of the display arrangement 11, wherein the contours 50C and 5IC of the children 50 and 51 are each represented together with a specification 50D and 51D relating to the distance between the motor vehicle 1 and the respective child 50 and 51.

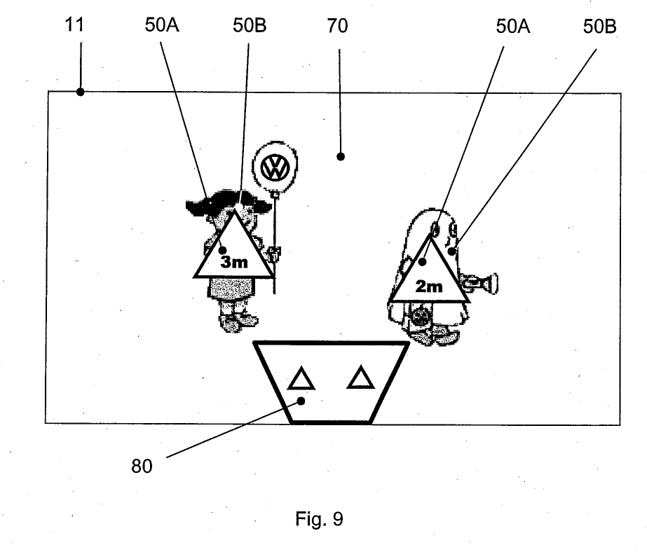

FIG. 9 illustrates another alternative example embodiment of a representation by means of the display arrangement 11, wherein the representation shown in FIG. 9 corresponds to that shown in FIG. 6, however without the superimposition of the boundary 71 of the scanning by the light beam 125. Instead of the boundary 71, an additional image 80 is superimposed, which describes the boundary of the scanning by the light beam 125.

### LIST OF REFERENCE NUMERALS

1 Motor vehicle
2 Rear light
3 Side mirror
4 Rearview mirror
10 Control system
11 Display arrangement
12 Obstacle sensor
20, 50, 51 Child
30 Mirror
31 Plate
32, 33 Torsional element
32A, 33A Torsional axis
34, 39 Frame
35, 36, 37, 38 Permanent magnet
50A, 51A Symbol
50B, 51B FIG.
50C, 51C Contour
50D, 51D Specification related to a distance
60, 61, 62 Step
70 Imaging
71 Boundary
80 Image
120 Laser
121 Two-dimensional scanning device
122 Camera
125 Light beam
126 Region
127 Reflected part of a light beam

1. A motor vehicle comprising:
a sensor for detecting an obstacle in the surroundings of the motor vehicle;
a control system for integrating a symbol for identifying a detected obstacle into an image of said surroundings of the motor vehicle or for assigning the symbol for identifying the detected obstacle to the image of said surroundings of the motor vehicle, wherein the position of the symbol relating to the image corresponds substantially to the position of the obstacle in the image; and
a display arrangement for representing the image of said surroundings of the motor vehicle together with the symbol.

2. A motor vehicle according to claim 1, wherein the symbol comprises a specification relating to a distance between the motor vehicle and the obstacle or is designed as a specification relating to a distance between the motor vehicle and the obstacle.

3. A motor vehicle according to claim 2, wherein the distance between the motor vehicle and the obstacle can be determined by the control system by means of a travel time measurement.

4. A motor vehicle according to claim 2, wherein the distance between the motor vehicle and the obstacle can be determined by the control system by means of interferometry.

5. A motor vehicle according to claim 1, wherein the symbol comprises a warning relating to the obstacle or is designed as a warning relating to the obstacle.

6. A motor vehicle according to claim 1, wherein the symbol comprises a specification relating to a distance between the motor vehicle and the obstacle and also a warning relating to the obstacle.

7. A motor vehicle according to claim 1, the sensor comprising:
a camera.

8. A motor vehicle according to claim 1, the sensor comprising:
a laser for emitting a light beam.

9. A motor vehicle according to claim 8, the sensor further comprising:
a camera adapted to a wavelength of the light beam.

10. A motor vehicle according to claim 8, the sensor further comprising:
a two-dimensional scanning device for moving the light beam in a first plane and also in a second plane orthogonal to the first plane, wherein the light beam is deflected in the surroundings of the motor vehicle.

11. A motor vehicle according to claim 10, wherein the two-dimensional scanning device comprises an MEMS (Micro-Electro-Mechanical System) or is designed as an MEMS.

12. A motor vehicle according to claim 10, the sensor further comprising:
a camera for detecting a part of the light beam, said part being reflected by said surroundings of the motor vehicle.

13. A motor vehicle according to claim 1, the sensor comprising:
a laser for emitting a light beam;
a two-dimensional scanning device for moving the light beam in a first plane and also in a second plane orthogonal to the first plane, wherein the light beam is deflected in the surroundings of the motor vehicle; and
a camera adapted to a wavelength of the light beam for detecting a part of the light beam, said part being reflected by said surroundings of the motor vehicle.

14. A motor vehicle according to claim 2, the sensor comprising:
a laser for emitting a light beam;
a two-dimensional scanning device for moving the light beam in a first plane and also in a second plane orthogonal to the first plane, wherein the light beam is deflected in the surroundings of the motor vehicle; and
a camera adapted to a wavelength of the light beam for detecting a part of the light beam, said part being reflected by said surroundings of the motor vehicle.

15. A motor vehicle according to claim 14, wherein the distance between the motor vehicle and the obstacle can be determined by means of the control system by measuring the thermal intensity in a wavelength of the light beam.

16. A motor vehicle according to claim 1, the sensor comprising:
a laser for emitting a light beam; and
a mirror for reflecting the light beam in the surroundings of the motor vehicle, wherein the mirror is connected to a first torsional element having a first torsional axis, wherein the first torsional element is connected to a second torsional element having a second torsional axis, and wherein the first torsional axis is directed substantially orthogonal to the second torsional axis or the first torsional axis has at least one component that is orthogonal to the second torsional axis.

17. A motor vehicle according to claim 16, the sensor further comprising:
a camera for detecting a part of the light beam, said part being reflected by said surroundings of the motor vehicle.

18. A method for operating a motor vehicle, said method comprising:
the detection of an obstacle in the surroundings of the motor vehicle;
the detection of an image of said surroundings of the motor vehicle; and
representation of the image of said surroundings of the motor vehicle together with a symbol for identifying a detected obstacle, wherein the symbol superimposes over the image at a position, which corresponds substantially to that of the obstacle in the image.

19. A motor vehicle, said motor vehicle comprising:
a laser for emitting a light beam;
a mirror for reflecting the light beam in the surroundings of the motor vehicle, wherein the mirror is connected to a first torsional element having a first torsional axis, wherein the first torsional element is connected to a second torsional element having a second torsional axis, and wherein the first torsional axis is directed substantially orthogonal to the second torsional axis or the first torsional axis has at least one component that is orthogonal to the second torsional axis;
a camera for detecting a part of the light beam, said part being reflected by said surroundings of the motor vehicle.

20. A motor vehicle according to claim 19, said motor vehicle further comprising:
a control system for determining the distance between the motor vehicle and the obstacle.

21. A motor vehicle according to claim 20, wherein the distance between the motor vehicle and the obstacle can be determined by the control system by means of a travel time measurement.

22. A motor vehicle according to claim 20, wherein the distance between the motor vehicle and the obstacle can be determined by the control system by means of interferometry.

23. A motor vehicle according to claim 20, wherein the distance between the motor vehicle and the obstacle can be determined by means of the control system by measuring the thermal intensity in a wavelength of the light beam.

24. Motor vehicle, said motor vehicle comprising:
a laser for emitting a light beam;
a two-dimensional scanning device for moving the light beam in a first plane and also in a second plane orthogonal to the first plane, wherein the light beam is deflected in the surroundings of the motor vehicle;
a camera for detecting a part of the light beam, said part being reflected by said surroundings of the motor vehicle.

25. A motor vehicle according to claim 24, said motor vehicle further comprising: a control system for determining the distance between the motor vehicle and the obstacle.

26. A motor vehicle according to claim 25, wherein the distance between the motor vehicle and the obstacle can be determined by the control unit by means of a travel time measurement.

27. A motor vehicle according to claim 25, wherein the distance between the motor vehicle and the obstacle can be determined by the control system by means of interferometry.

28. A motor vehicle according to claim 25, wherein the distance between the motor vehicle and the obstacle can be determined by means of the control system by measuring the thermal intensity in a wavelength of the light beam.

29. A motor vehicle, said motor vehicle comprising:
a sensor arrangement for determining the distance between the motor vehicle and an obstacle in the surroundings of the motor vehicle and also for determining the contour of the obstacle;
a control unit for integrating a specification relating to the distance between the motor vehicle and a detected obstacle into the contour of the detected obstacle or for assigning said specification and said contour; and
a display arrangement for representing said contour together with said specification, wherein the position of said specification is located in the vicinity of that of said contour.

30. A motor vehicle according to claim 29, wherein the distance between the motor vehicle and the obstacle can be determined by means of a travel time measurement.

31. A motor vehicle according to claim 29, wherein the distance between the motor vehicle and the obstacle can be determined by means of interferometry.

32. A motor vehicle according to claim 29, the sensor arrangement comprising:
a camera.

33. A motor vehicle according to claim 29, the sensor arrangement further comprising:
a laser for emitting a light beam.

34. A motor vehicle according to claim 33, the sensor arrangement further comprising: a camera adapted to a wavelength of the light beam.

35. A motor vehicle according to claim 33, the sensor arrangement further comprising:
a two-dimensional scanning device for moving the light beam in a first plane and also in a second plane orthogonal to the first plane, wherein the light beam is deflected in the surroundings of the motor vehicle.

36. A motor vehicle according to claim 35, wherein the two-dimensional scanning device comprises an MEMS (Micro-Electro-Mechanical System) or is designed as an MEMS.

37. A motor vehicle according to claim 35, the sensor arrangement further comprising:
a camera for detecting a part of the light beam, said part being reflected by said surroundings of the motor vehicle.

38. A motor vehicle according to claim 29, the sensor arrangement comprising:
a laser for emitting a light beam;
a two-dimensional scanning device for moving the light beam in a first plane and also in a second plane orthogonal to the first plane, wherein the light beam is deflected in the surroundings of the motor vehicle; and
a camera adapted to a wavelength of the light beam for detecting a part of the light beam, said part being reflected by said surroundings of the motor vehicle.

39. A motor vehicle according to claim 38, wherein the distance between the motor vehicle and the obstacle can be determined by measuring the thermal intensity in a wavelength of the light beam.

40. A motor vehicle according to claim 29, the sensor arrangement comprising:
a laser for emitting a light beam; and a mirror for reflecting the light beam in the surroundings of the motor vehicle, wherein the mirror is connected to a first torsional element having a first torsional axis, wherein the first torsional element is connected to a second torsional element having a second torsional axis, and wherein the first torsional axis is substantially directed orthogonal to the second torsional axis or the first torsional axis has at least one component that is orthogonal to the second torsional axis.

41. A motor vehicle according to claim 40, the sensor arrangement further comprising:
a camera for detecting a part of the light beam, said part being reflected by said surroundings of the motor vehicle.
